(19) United States
(12) Patent Application Publication
(10) Pub. No.: US 2017/0057797 A1
(43) Pub. Date: Mar. 2, 2017

(54) Forklift Truck Brake System

(71) Applicant: Big Lift, LLC, Lombard, IL (US)

(72) Inventor: Yu Xiaoxian, Hangzhou (CN)

(21) Appl. No.: 14/976,287

(22) Filed: Dec. 21, 2015

(30) Foreign Application Priority Data
Sep. 2, 2015 (CN) 201520444211.4

(51) Int. Cl. B66F 9/075; F16D 55/225

(52) U.S. Cl. CPC B66F 9/07509; F16D 55/225; B66F 9/07572

(57) ABSTRACT

A forklift truck brake system includes a drive, a gear box, a traction motor connected to the gear box, wheels and tires rotatably mounted on opposed ends of the drive axle, the gear box being connected to the drive axle, and the traction motor causes rotation through the gear box to rotate the wheels and tires. The system also includes a brake disc installed on an output shaft of the traction motor, and a brake is configured to clamp the brake disc and stop it from rotating. The brake is used to make the brake disc on the output shaft of the traction motor stop rotating, so that the traction motor stops rotating, and the brake force of the motor is amplified by the gear box and drive axle, to achieve quick braking and reduce the braking distance.

### CROSS-REFERENCE TO RELATED APPLICATION

This application claims priority to Chinese Patent Application No. 201520444211.4, filed Sep. 2, 2015, which is hereby incorporated by reference in its entirety.

### FIELD OF THE INVENTION

The disclosure relates to forklift trucks, and more particularly to a brake system used on a forklift truck.

### BACKGROUND

Forklift trucks are industrial vehicles and may be of various wheeled types. Forklift trucks may be used for cargo loading and unloading, stacking and short distance transportation operations. The international standards organization ISO/TC110 refers to them as industrial vehicles, and forklift trucks commonly are used to transport large objects, usually using a motor that includes a fueled engine or a battery drive.

The performance of a forklift truck mainly depends on its acceleration performance and braking performance. The braking system performance is directly related to the safety of the operator and/or individuals working in the vicinity of the forklift truck, so it is very important to evaluate the braking system performance of a forklift truck. Traditional forklift truck brake systems are generally designed with brake hubs installed in the wheel hubs, tires on the wheels follow wheel steering, and brake hubs will stop the wheels. With this configuration, the braking force, at times, may not seem adequate, and the distance required for braking may be very long. As such, it is difficult to achieve rapid and/or sensitive braking, and the brake hubs installed on both ends of a drive axle are expensive. Also, due to the brake hubs being installed in the wheel hubs, the total wheel size must be larger, thereby increasing the entire wheel weight, and increasing the balance between the weight of the wheels and of the forklift truck, and increasing the entire forklift truck weight.

Traditional forklift truck brake systems have problems that are based on the brake hub installation, and that result in low braking force, long braking distances, high system and wheel weight and high cost.

### SUMMARY

In order to solve the known technical problems, the forklift truck brake system of the present disclosure utilizes the following technical scheme. A forklift truck brake system includes a drive axle, a gear box, a traction motor and wheels and tires rotatably mounted on the opposed ends of the drive axle, wherein the gear box is connected to the drive axle, and the traction motor causes rotation through the gear box. The brake system also includes a brake disc installed on an output shaft of the traction motor, and a brake, such as a brake caliper, that will clamp the brake disc and make it stop rotating.

When a forklift truck is braking, a brake of the disclosed brake system clamps the brake disc, which is installed on the traction motor output shaft. The role of the brake disc is to make the motor gradually stop rotating. Also, in light of the increased gear ratio from the gear box, under the action of the gear box and the drive axle, the final braking force at the wheels and tires is increased, so as to realize a braking system having fast braking, and reduced braking distance. Meanwhile, because the brake acts directly on the brake disc that is connected to the traction motor, only one brake is needed to achieve fast braking, compared to having two brake hubs on both ends of the drive axle. This effectively saves cost and reduces the required wheel size, volume and weight, and ultimately reduces the balance between the weight of the wheels and the weight of the whole forklift truck, so that the brake performance is improved.

In the preferred example, the gear box is connected to a middle part of the drive axle by bolts. The traction motor also is connected to the gear box by bolts. By using bolted connections, the gear box and motor installation and service are much more convenient, and it is easier to maintain the whole brake system.

The disclosure provides an advantageous technical effect by adopting the above technical scheme, wherein the forklift truck brake system uses a brake to make the brake disc, which is on the output shaft of the traction motor, stop rotating, so that the traction motor stops rotating. Additionally, the brake force applied at the motor is amplified by the gear box and drive axle, to achieve the quick braking and reduce the braking distance.

### BRIEF DESCRIPTION OF THE DRAWINGS

FIG. 1 is a top view of an example forklift truck brake system in accordance with the present disclosure; and

FIG. 2 is a side view of the example shown in FIG. 1.

The components in the drawings are referred to as follows: drive axle 1, gear box 2, traction motor 3, tires 4, brake disc 5, brake 6, and wheel hub 7. A further detailed description of the drawings and examples is presented below.

### DETAILED DESCRIPTION OF THE PREFERRED EMBODIMENT

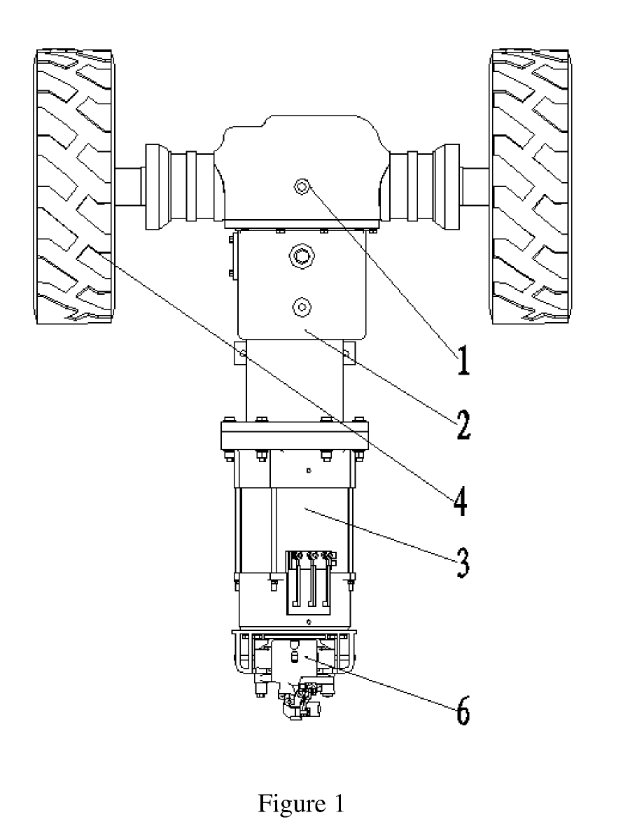

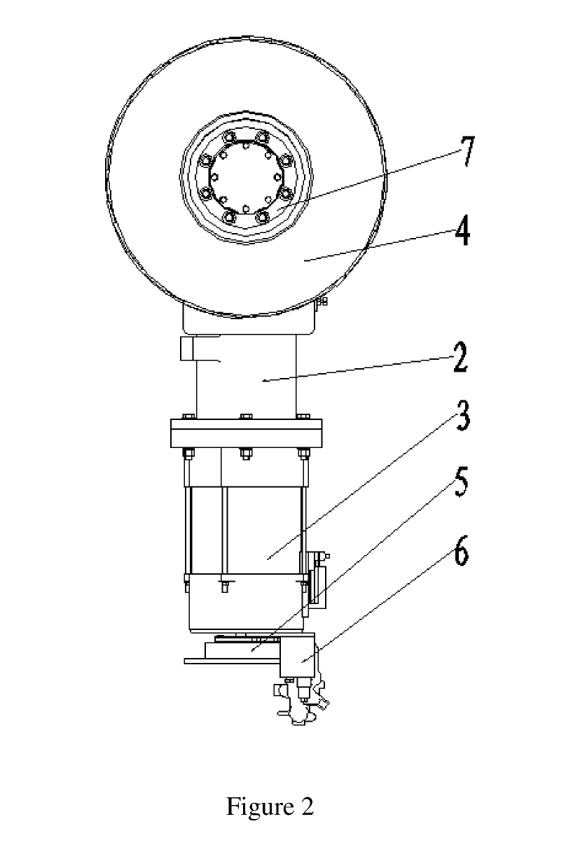

A forklift truck brake system is shown in FIGS. 1 and 2, and includes a drive axle 1, a gear box 2, a traction motor 3, two wheel hubs 7 rotatably mounted on the opposed ends of the drive axle 1, tires 4 mounted on the wheel hubs 7, wherein the gear box 2 is connected to the drive axle 1, the traction motor 3 is connected to the gear box 2 by bolts and causes rotation through the gear box 2. The brake system also includes a brake disc 5 that is installed on an output shaft of the traction motor 3, and a brake 6 that clamps the brake disc 5 and stops its rotation.

When operating, the rotation of the traction motor 3 causes rotation through the gearbox 2 and drive axle 1 to drive the wheels and tires 4, thereby achieving the forklift truck driving. When braking, the brake 6 will clamp the brake disc 5 to make the traction motor 3 stop rotating, and through the gear box 2 and drive axle 1 that amplify the braking force, the brake system will achieve the purpose of forklift truck braking.

The brake disc 5 is directly mounted on the output shaft of the traction motor 3, so through the brake 6 clamping the brake disc 5 to stop its rotation, the rotation of the output shaft and the traction motor 3 are stopped. Also, due to the traction motor 3 and gearbox 2 being connected, when the traction motor 3 gradually stops rotating, the rotational speed of the gear box 2 and output shaft also gradually slows, while benefitting from the increased gear box 2 ratio. The increased gear box 2 ratio will amplify the final braking force at the wheel hubs, so that the forklift truck can achieve fast braking, and shorten the braking distance.

In addition, because the brake disc 5 is directly mounted on the output shaft of the traction motor 4, and the brake 6 directly affects the brake disc 5, the brake hubs do not have to be installed in the wheel hubs. This may greatly reduce the weight of the wheel hubs, and thereby reduce the volume and weight of the wheels and tires, and ultimately reduce the balance between the weight of the wheels and tires and the weight of the whole forklift truck, as well as the overall weight of the forklift truck, resulting in brake performance that will be more sensitive. Further, because the brake 6 directly affects the brake disc 5 that is installed on the output shaft of the traction motor 3, only one brake 6 and brake disc 5 are needed to achieve braking, greatly saving on costs compared to traditional designs where two brakes hubs are needed, one on each end of the drive axle 1.

It will be understood that the above example presents a preferred embodiment, but the patent is entitled to a range of equivalents and is directed to embodiments that may include modifications, as long as they fall within the coverage of the claims.

1. A forklift truck brake system comprising:
a drive axle,
a gear box,
a traction motor connected to the gear box,
wheels and tires rotatably mounted on opposed ends of the drive axle,
wherein the gear box is connected to the drive axle and the traction motor causes rotation of the wheels and tires through the gear box, and
wherein a brake disc is installed on an output shaft of the traction motor, and a brake is configured to clamp and stop rotation of the brake disc.

2. The forklift truck brake system according to claim 1, wherein the gear box is connected to a middle part of the drive axle by bolts.

3. The forklift truck brake system according to claim 1, wherein the traction motor is connected to the gear box by bolts.
